(19) United States
(12) Patent Application Publication
(10) Pub. No.: US 2016/0044623 A1
(43) Pub. Date: Feb. 11, 2016

(54) METHOD AND APPARATUS FOR CONTROLLING BASE STATION

(71) Applicant: Electronics and Telecommunications Research Institute, Daejeon (KR)

(72) Inventors: Hee Sang CHUNG, Daejeon (KR); Il Gyu KIM, Chungcheongbuk-do (KR)

(21) Appl. No.: 14/820,164

(22) Filed: Aug. 6, 2015

(30) Foreign Application Priority Data
Aug. 7, 2014 (KR) 10-2014-0101964
Aug. 5, 2015 (KR) 10-2015-0110763

(51) Int. Cl. H04W 56/00

(52) U.S. Cl. CPC H04W 56/0065

(57) ABSTRACT

Provided are a method and apparatus for controlling a plurality of base stations disposed along the moving path of a moving group object, including determining a frame offset for the plurality of base stations based on a first delay time generated between the moving group object and the plurality of base stations and a second delay time generated between the plurality of base stations and the base station control device, and transferring data to be transmitted to the moving group object to the plurality of base stations based on the frame offset.

### CROSS-REFERENCE TO RELATED APPLICATION

This application claims priority to and the benefit of Korean Patent Application Nos. 10-2014-0101964 and 10-2015-0110763 filed in the Korean Intellectual Property Office on Aug. 7, 2014 and Aug. 5, 2015, the entire contents of which are incorporated herein by reference.

### BACKGROUND OF THE INVENTION

(a) Field of the Invention

The present invention relates to a method and apparatus for controlling a base station disposed in the moving path of a moving group object.

(b) Description of the Related Art

A user within a moving group object moving at high speed, such as a train or a bus, may access the Internet using two methods. The first method is a method of directly accessing, by a user within a moving group object, a base station outside the moving group object. A user may directly access a base station of a mobile communication network, such as 3^{rd} generation (3G) or long term evolution (LTE) network, even within a moving group object. A method of directly accessing, by a user, a base station is also called a 1 hierarchy system. The second method is a method of accessing, by a user within a moving group object, a base station outside the moving group object through an access point (AP) within the moving group object. In this case, the user may use wireless fidelity (Wi-Fi) or the AP of a femto cell. A method of indirectly accessing, by a user, a base station using an AP within a moving group object is also called a 2 hierarchy system.

In a 1 hierarchy system, a user who has boarded a bus, subway, or high-speed railway directly accesses a mobile communication base station. A base station does not distinguish a user included in a moving group object from a common user. Accordingly, there may be some problems if a passenger who has boarded a moving group object moving at high speed is provided with a data service through the 1 hierarchy system. First, data transmission speed of a mobile communication service may be reduced due to the high mobility of a user included in a moving group object because the data transmission speed is reduced as the mobility of a user is increased. Furthermore, data transmission speed may be further reduced due to competitive access to a cellular network because several tens or several hundreds of users are included in a moving group object. Furthermore, there may also be a problem in the base station handover of a user. In general, the coverage of a cellular network is about 1 km in a downtown area and about several kilometers in a suburb. If a plurality of users included in a moving group object simultaneously pass through the boundary of a cell, a lot of handover is simultaneously generated and a handover failure probability is increased. Accordingly, if a user of a moving group object uses a 1 hierarchy system, data transmission speed may be reduced, and a handover failure probability may be increased.

In a 2 hierarchy system, a base station outside a moving group object recognizes an AP included in the moving group object as a single user. In this case, a wireless section formed between the base station and the AP of the moving group object is called a “wireless backhaul.”

In this case, in order to highlight the mobility of the moving group object, the wireless backhaul between the moving group object and the base station is called a “mobile wireless backhaul” as a term compared to a fixed backhaul. A data service for a user included in a moving group object is provided through the AP of the moving group object. Accordingly, the problems of the 1 hierarchy system may be solved by improving the performance of the mobile wireless backhaul. That is, if it is possible to increase data transmission speed of the mobile wireless backhaul and to increase a handover success rate in the mobile wireless backhaul when a moving group object moves at high speed, a user included in the moving group object may share a data service guaranteed by the mobile wireless backhaul.

A mobile wireless backhaul section in the 2 hierarchy system includes communication between a moving group object and a satellite and communication between a moving group object and a cellular base station. In both the communication methods, downlink download speed of about 10-20 Mbps may be provided to a user included in a moving group object. Furthermore, there appear some cases in which a millimeter-wave frequency used in a fixed backhaul is applied to a mobile wireless backhaul.

### SUMMARY OF THE INVENTION

The present invention has been made in an effort to provide a method and apparatus for controlling a base station, which facilitate the handover of a moving group object by simplifying a handover procedure between the base stations of the moving group object in the 2 hierarchy system of the moving group object.

In accordance with an exemplary embodiment of the present invention, there is provided a method of controlling, by a base station control device, a plurality of base stations disposed along the moving path of a moving group object. The method includes determining a frame offset for the plurality of base stations based on a first delay time generated between the moving group object and the plurality of base stations and a second delay time generated between the plurality of base stations and the base station control device, and transferring data to be transmitted to the moving group object to the plurality of base stations based on the frame offset.

In the method, determining the frame offset may include: calculating the first delay time of each of the plurality of base stations based on a first distance between the moving group object and the plurality of base stations, and transfer speed of a signal in the air; calculating the second delay time of each of the plurality of base stations based on a second distance between the plurality of base stations and the base station control device and transfer speed of a signal in an optical fiber connecting the plurality of base stations and the base station control device; and determining the frame offset based on the first delay time and the second delay time.

In the method, determining the frame offset based on the first delay time and the second delay time may include determining a first base station that belongs to the plurality of base stations and that has the smallest final delay time that is the sum of the first delay time and the second delay time, and determining a frame offset based on the final delay time of the first base station and the final delay time of base stations of the plurality of base stations other than the first base station.

In the method, if the moving path is a curved line, a first interval between the plurality of base stations may be shorter than a second interval between base stations disposed in a moving path of a straight line.

The method may further include assigning the same cell identity (ID) to the plurality of base stations and determining a point of time at which the transmission of signals of the plurality of base stations is stopped based on the uplink signal of the moving group object.

In the method, the uplink signal may include the sounding reference signal of the moving group object.

The uplink signal may include a measurement result of the intensity of a signal which has been measured by the moving group object and which corresponds to the data.

The method may further include assigning different cell IDs to the plurality of base stations and determining a point of time at which the transmission of signals of the plurality of base stations is stopped based on an uplink signal generated based on the cell IDs in the moving group object.

In accordance with another exemplary embodiment of the present invention, there is provided a base station control device for controlling a plurality of base stations disposed along the moving path of a moving group object. The base station control device includes at least one processor, a memory, and a radio frequency (RF) unit. The at least one processor determines a frame offset for the plurality of base stations based on a first delay time generated between the moving group object and the plurality of base stations and a second delay time generated between the plurality of base stations and the base station control device, and transferring data to be transmitted to the moving group object to the plurality of base stations based on the frame offset by executing at least one program stored in the memory.

When determining the frame offset, the at least one processor may calculate the first delay time of each of the plurality of base stations based on a first distance between the moving group object and the plurality of base stations and transfer speed of a signal in air, may calculate the second delay time of each of the plurality of base stations based on a second distance between the plurality of base stations and the base station control device and transfer speed of a signal in an optical fiber connecting the plurality of base stations and the base station control device, and may determine the frame offset based on the first delay time and the second delay time.

When determining the frame offset based on the first delay time and the second delay time, the at least one processor may determine a first base station that belongs to the plurality of base stations and that has the smallest final delay time that is the sum of the first delay time and the second delay time, and may determine a frame offset based on the final delay time of the first base station and the final delay time of base stations of the plurality of base stations other than the first base station.

If the moving path is a curved line, a first interval between the plurality of base stations may be shorter than a second interval between base stations disposed in a moving path of a straight line.

The at least one processor may assign the same cell ID to the plurality of base stations and determine a point of time at which the transmission of signals of the plurality of base stations is stopped based on the uplink signal of the moving group object by executing the at least one program.

In the base station control device, the uplink signal may include the sounding reference signal of the moving group object.

In the base station control device, the uplink signal may include a measurement result of the intensity of a signal which has been measured by the moving group object and which corresponds to the data.

In the base station control device, the at least one processor may assign different cell IDs to the plurality of base stations and determine a point of time at which transmission of signals of the plurality of base stations is stopped based on an uplink signal generated based on the cell IDs in the moving group object by executing the at least one program.

In accordance with another exemplary embodiment of the present invention, there is provided a method of sending data, by a base station disposed along the moving path of a moving group object. The data transmission method includes receiving a frame offset with respect to a base station adjacent to the base station from a base station control device of the base station and sending the data to the moving group object based on the frame offset.

In the data transmission method, the frame offset may be calculated based on a first delay time generated between the moving group object and the base station and a second delay time generated between the base station and the base station control device.

In the data transmission method, if the moving path is a curved line, an interval between the base station and the adjacent base station may be shorter than an interval between other base stations disposed in a moving path of a straight line.

The data transmission method may further include receiving an uplink signal from the moving group object and stopping the transmission of a signal for the data based on a point of time at which the transmission of the signal is stopped, which is determined based on the uplink signal.

### BRIEF DESCRIPTION OF THE DRAWINGS

FIG. 1 is a diagram illustrating a moving group object moving between base stations installed at the roadside.

FIG. 2 is a diagram illustrating a moving group object moving between base stations installed at the roadside in accordance with an exemplary embodiment of the present invention.

FIG. 3 is a diagram illustrating a wireless communication system in accordance with an exemplary embodiment of the present invention.

FIGS. 4A and 4B are diagrams illustrating the frame offset of a digital signal in accordance with an exemplary embodiment of the present invention.

FIGS. 5, 6, and 7 are diagrams illustrating the frame offset of a straight section in accordance with an exemplary embodiment of the present invention.

FIG. 8 is a flowchart illustrating a method of controlling, by a base station control device, a base station in accordance with an exemplary embodiment of the present invention.

FIG. 9 is a diagram illustrating a moving group object operating in a curved line section in accordance with an exemplary embodiment of the present invention.

FIGS. 10 and 11 are diagrams illustrating a method of calculating a frame offset in a curved line section.

FIG. 12 is a diagram illustrating a wireless communication system including a plurality of base station control devices in accordance with an exemplary embodiment of the present invention.

FIG. 13 is a block diagram illustrating a wireless communication system in accordance with an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, a mobile station (MS) may refer to a terminal, a mobile terminal (MT), an advanced mobile station (AMS), a high reliability mobile station (HR-MS), a subscriber station (SS), a portable subscriber station (PSS), an access terminal (AT), or user equipment (UE), and may include some or all of the functions of the terminal, MT, AMS, HR-MS, SS, PSS, AT, and UE.

Furthermore, a base station (BS) may refer to an advanced base station (ABS), a high reliability base station (HR-BS), a nodeB, an evolved node B (eNodeB), an access point (AP), a radio access station (RAS), a base transceiver station (BTS), a mobile multihop relay (MMR)-BS, a relay station (RS) functioning as a base station, a relay node (RN) functioning as a base station, an advanced relay station (ARS) functioning as a base station, a high reliability relay station (HR-RS) functioning as a base station, or a small base station [e.g., a femto BS, a home node B (HNB), a home eNodeB (HeNB), a pico BS, a macro BS, or a micro BS], and may include some or all of the functions of the ABS, HR-BS, nodeB, eNodeB, AP, RAS, BTS, MMR-BS, RS, RN, ARS, HR-RS, and small base station.

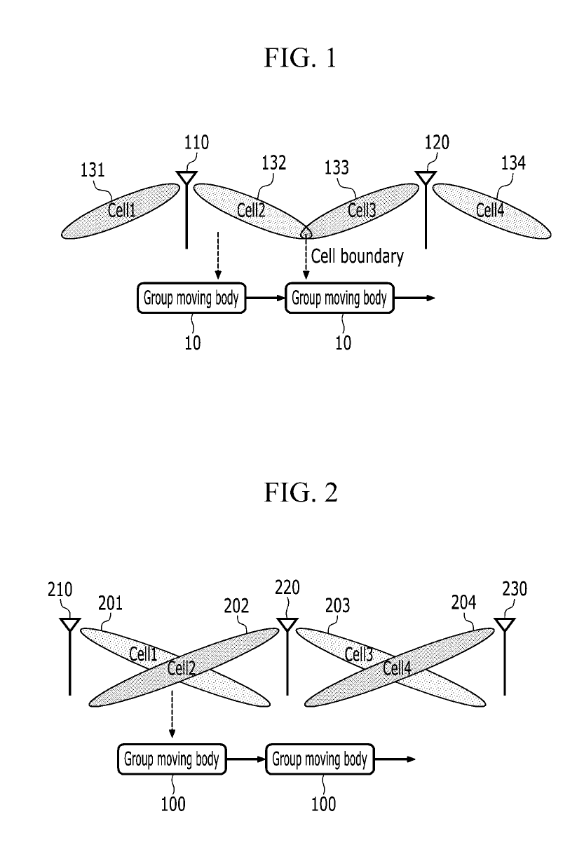

FIG. 1 is a diagram illustrating a moving group object moving between base stations installed in the roadside.

Referring to FIG. 1, in the wireless communication system of a moving group object 10, base stations 110 and 120 are placed along the roadside (e.g., a road or a train railway line). The moving group object 10 moves along the road or train railway line. In this case, the moving group object 10 identically receives radio waves incoming in all directions and identically sends radio waves in all directions.

Referring to FIG. 1, a cell1 131 and a cell2 132 may be formed at the front and back of the base station 110, and a cell3 133 and a cell4 134 may be formed at the front and back of the base station 120. In FIG. 1, the moving group object 10 moves from the cell2 132 to the cell3 133, the intensity of a signal received from the cell2 132 gradually becomes weak, and the intensity of a signal received from the cell3 133 gradually becomes strong. When the moving group object 10 reaches the boundary of the cell2 132 and the cell3 133, the intensity of the signal received from the cell2 132 becomes similar to that received from the cell3 133. The moving group object 10 performs handover from the cell2 132 to the cell3 133.

FIG. 2 is a diagram illustrating a moving group object moving between base stations installed in the roadside in accordance with an exemplary embodiment of the present invention.

Referring to FIG. 2, base stations 210, 220, and 230 may perform wireless communication with a moving group object 100 using a millimeter wave through antennas.

In general, a base station includes a radio unit (RU) and a digital unit (DU). A base station in accordance with an exemplary embodiment of the present invention may refer to an antenna and an RU connected to the antenna. The DU of each base station may be included in a DU-centralized station, such as a base station control device.

The moving group object 100 includes at least one processor, at least one piece of memory, and at least one radio frequency (RF) unit. The moving group object 100 may relay communication between a base station and a plurality of terminals placed within the moving group object 100. That is, the moving group object 100 may function as a single terminal in the relationship with a base station and may function as a base station in the relationship with a plurality of terminals placed in the moving group object 100. A millimeter wave is placed in a frequency bandwidth of 30-300 GHz, and has strong straightness and a high path loss compared to the radio wave of an existing cellular frequency bandwidth. In contrast, the millimeter wave permits a reduction in the size of an antenna and may be used to fabricate a small array antenna because the wavelength of a carrier frequency is short. Furthermore, the path loss of a signal can be compensated because a beam having good directivity can be formed.

Referring to FIG. 2, if the moving group object 100 belongs to a cell1 201 and a cell2 202, the moving group object 100 is supplied with a service from one of the cell1 201 and the cell2 202 due to the directivity of the transmission/reception antenna of the moving group object 100. If the moving group object 100 includes both a transmission/reception device for the cell1 201 and a transmission/reception device for the cell2 202, the transmission/reception devices for the cell1 and the cell2 may be controlled in one of the cell1 201 and the cell2 202. However, the transmission/reception device for the cell1 201 experiences small interference from the cell2 202 due to high directivity for the cell1 201 although the moving group object 100 is placed in the coverage of the cell2 202. Furthermore, the transmission/reception device for the cell2 202 may experience small interference from the cell1 201 due to high directivity for the cell2 202 although the moving group object 100 is placed in the coverage of the cell1 201. That is, if a base station performs wireless communication with the moving group object 100 using a millimeter wave as in FIG. 2, the coverage of a cell formed by each base station may be overlapped in many portions due to the high directivity of the transmission/reception device. FIG. 2 illustrates the case where the transmission/reception device of the moving group object 100 is for the cell2 202 and the moving group object 100 moves toward a cell4 204. When the moving group object 100 reaches the boundary of the cell2 202 and the cell4 204, the moving group object 100 performs handover from the cell2 202 to the cell4 204 because the intensity of the signal of the cell2 202 received by the moving group object 100 becomes similar to that of the signal of the cell4 204 received by the moving group object 100. If a cell is configured using a millimeter wave having a great beam gain, when the moving group object 100 passes by the second base station 220, the intensity of a signal from the cell2 202 is suddenly reduced, and the intensity of a signal from the cell4 204 is gently increased. As a result, the intensities of signals received from the cell2 202 and the cell4 204 may become similar.

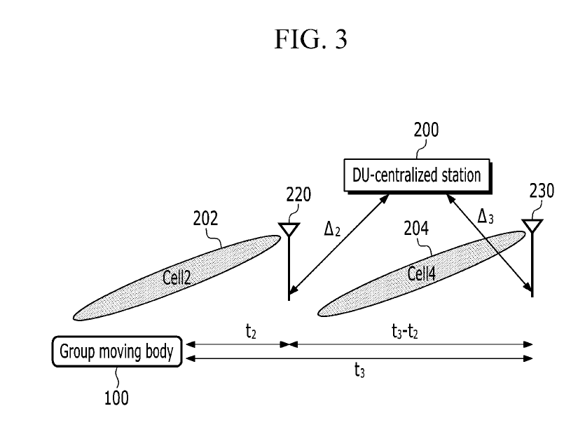

FIG. 3 is a diagram illustrating a wireless communication system in accordance with an exemplary embodiment of the present invention.

Referring to FIG. 3, the wireless communication system in accordance with an exemplary embodiment of the present invention includes a base station control device 200, a plurality of base stations 220 and 230, and a moving group object 100.

The base station control device 200 processes a digital signal and sends/receives a digital signal to the plurality of base stations 220 and 230. The base station control device 200 is connected to the base station using a wire, such as an optical fiber. For example, the base station control device 200 may be a device such as a DU-centralized station including a plurality of data units (DUs) for respective base stations, and may control signals to be transmitted and received to and from the plurality of base stations through a wire such as an optical fiber. The signal transfer time between the base station control device 200 and each of the base stations may be proportional to the refractive index of the optical fiber and the length of the optical fiber. Referring to FIG. 3, the signal transfer time between the base station control device 200 and the second base station 220 is Δ₂, and the signal transfer time between the base station control device 200 and the third base station 230 is Δ₃.

The plurality of base stations may be placed along the moving path of the moving group object 100, and may receive a signal from the moving group object 100 and may transfer the signal to the base station control device 200 or receive a signal to be transmitted to the moving group object 100 from the base station control device 200. In the base station control device 200 in accordance with an exemplary embodiment of the present invention, if a digital signal is processed, each of the plurality of base stations in accordance with an exemplary embodiment of the present invention may include an antenna and an RU.

The moving group object 100 is transportation means (e.g., a bus, train, or high-speed railway) including a transmission/reception device for performing wireless communication with a plurality of base stations placed on the path of the moving group object 100. A plurality of users, each including wireless communication equipment, have boarded the moving group object 100.

Referring to FIG. 3, the time that is taken for a signal from the second base station 220 to reach the moving group object 100 is t₂, and the time that is taken for a signal from the third base station 230 to reach the moving group object 100 is t₃. The time that is taken for the signal to reach the moving group object 100 may be determined in proportion to the distance between the moving group object 100 and the base station. If the second base station 220 and the third base station 230 have simultaneously transmitted the signals to the moving group object 100, the moving group object 100 may receive the signal from the third base station 230 after a time t₃-t₂ since it received the signal from the second base station 220.

When the signal transmitted by the base station control device 200 reaches the moving group object 100 through the second base station 220 (i.e., a first path), a signal transfer time is t₂+Δ₂. When the signal transmitted by the base station control device 200 reaches the moving group object 100 through the third base station 230 (i.e., a second path), a signal transfer time is t₃+Δ₃. That is, when the signal generated by the base station control device 200 reaches the moving group object 100 through the first path and the second path, a difference Δ₂₃ between the signal transfer times is represented by Equation 1 below.

Δ₂₃(t₃+Δ₃)−(t₂+Δ₂) (Equation 1)

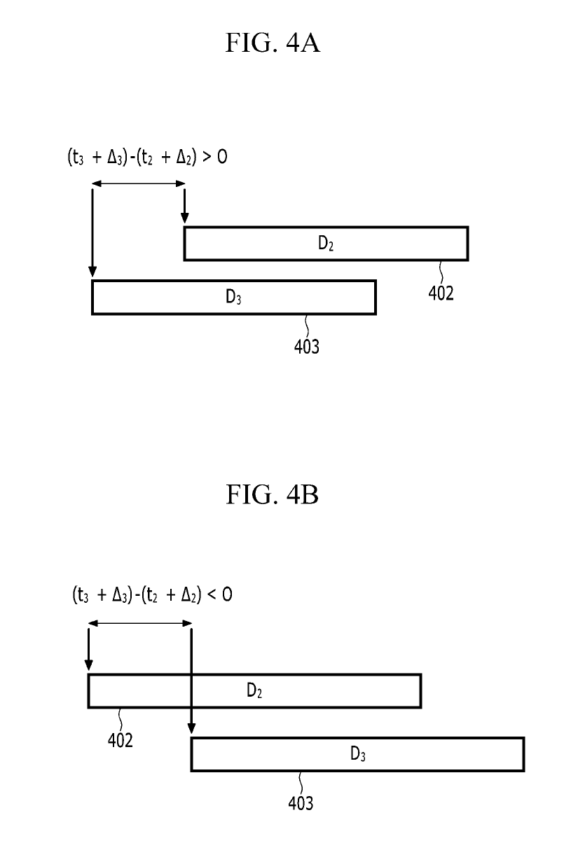

FIGS. 4A and 4B are diagrams illustrating the frame offset of a digital signal in accordance with an exemplary embodiment of the present invention. Referring to FIGS. 4A and 4B, the frame offset of a digital signal in accordance with an exemplary embodiment of the present invention may be calculated based on a difference Δ₂₃ in the signal transfer time between a digital signal D₂ 402 that has reached the moving group object 100 through the second base station 220 and a digital signal D₃ 403 that has reached the moving group object 100 through the third base station 230.

Referring to FIG. 4A, if the difference Δ₂₃ is a positive number (i.e., Δ₂₃>0), the digital signal D₃ 403 may be transmitted toward the third base station 230 earlier than the digital signal D₂ 402 by the difference Δ₂₃. That is, each of poles illustrated in FIGS. 4A and 4B is indicative of a digital signal. FIGS. 4A and 4B illustrate that the digital signal D₃ 403 has been transmitted toward the third base station 230 earlier than the digital signal D₂ 402 by the difference Δ₂₃. Accordingly, the digital signals D₂ 402 and D₃ 403 may reach the moving group object 100 at the same time.

Referring to FIG. 4B, if the difference Δ₂₃ is a negative number (i.e., Δ₂₃<0), the digital signal D₂ 402 may be transmitted toward the second base station 220 earlier than the digital signal D₃ 403 by the difference Δ₂₃. Accordingly, the digital signals D₂ 402 and D₃ 403 may reach the moving group object 100 at the same time.

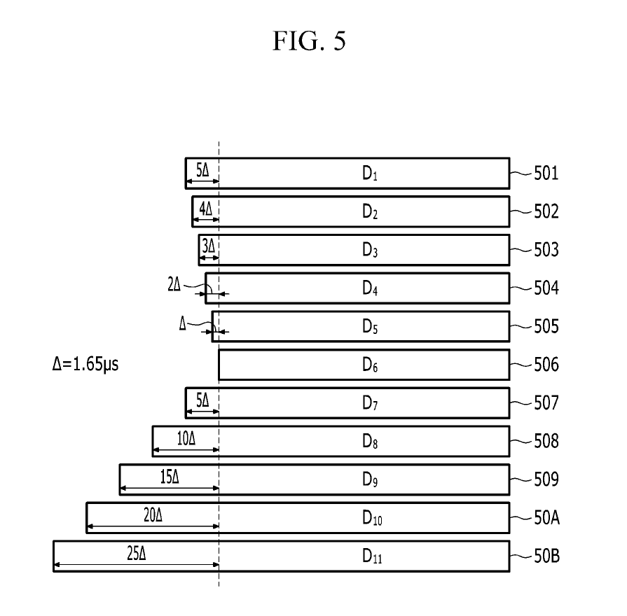

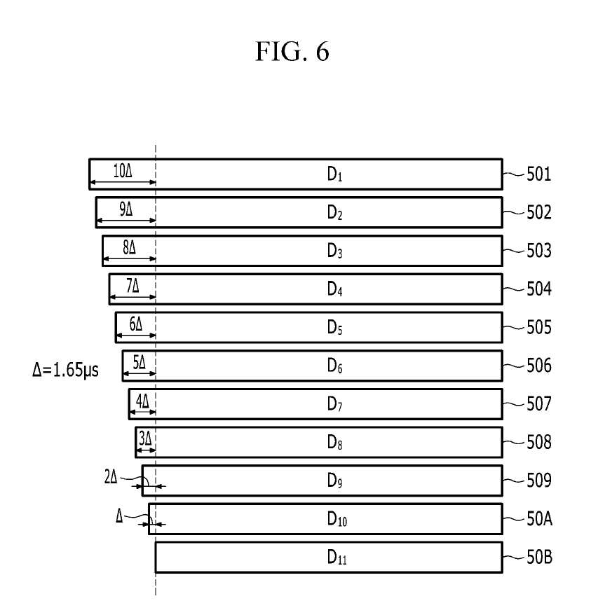

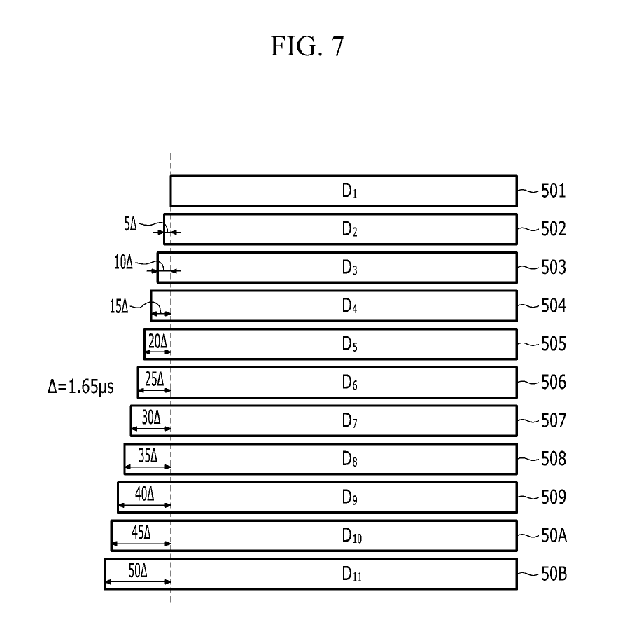

FIGS. 5, 6, and 7 are diagrams illustrating the frame offset of a straight section in accordance with an exemplary embodiment of the present invention.

FIGS. 5 to 7 illustrate the frame offsets of digital signals 501 to 50B if 11 base stations are connected to a single base station control device 200. The 11 base stations are placed in the straight section of the moving path of the moving group object 100.

In an exemplary embodiment of the present invention, if the refractive index of an optical fiber from the base station control device 200 to each of the base stations is 1.5, a delay time Δₙ that is taken for a signal transferred to the optical fiber to move 1 km is 4.95 μs (i.e., speed of the signal is assumed to be 1/1.5 times of velocity of light), and a delay time tₙ that is taken for a signal to be transferred from each of the base stations to the moving group object 100 1 km in the air is 3.3 μs (i.e., speed of the signal is assumed to be velocity of light).

Table 1 illustrates the frame offset of each base station if the base station control device 200 is placed near a sixth base station 260. In Table 1, the base station control device 200 is placed at a point closest to the sixth base station 260, and the moving group object 100 is assumed to move from the first base station 210 to an eleventh base station. Accordingly, the distance between the optical fiber and the sixth base station 260 is 0, and the distance between the moving group object 100 and the first base station 210 is also 0.

TABLE 1

| Base | Distance | | Dis- | | | | |
|---|---|---|---|---|---|---|---|
| sta- | [km] | Time | tance | Time | Time | Differ- | Ratio |
| tion | (optical | [μs] | [km] | [μs] | [μs] | ence | (Δ = 1.65 |
| No. | fiber) | (Δₙ) | (air) | (tₙ) | (tₙ + Δₙ) | [μs] | μs) |
| 1 | 5 | 24.75 | 0 | 0 | 24.75 | 8.25 | 5Δ |
| 2 | 4 | 19.8 | 1 | 3.3 | 23.1 | 6.6 | 4Δ |
| 3 | 3 | 14.85 | 2 | 6.6 | 21.45 | 4.95 | 3Δ |
| 4 | 2 | 9.9 | 3 | 9.9 | 19.8 | 3.3 | 2Δ |
| 5 | 1 | 4.95 | 4 | 13.2 | 18.15 | 1.65 | 1Δ |
| 6 | 0 | 0 | 5 | 16.5 | 16.5 | 0 | 0Δ |
| 7 | 1 | 4.95 | 6 | 19.8 | 24.75 | 8.25 | 5Δ |
| 8 | 2 | 9.9 | 7 | 23.1 | 33 | 16.5 | 10Δ |
| 9 | 3 | 14.85 | 8 | 26.4 | 41.25 | 24.75 | 15Δ |
| 10 | 4 | 19.8 | 9 | 29.7 | 49.5 | 33 | 20Δ |
| 11 | 5 | 24.75 | 10 | 33 | 57.75 | 41.25 | 25Δ |

Table 2 illustrates the frame offset of each base station if the base station control device 200 is placed near the eleventh base station. In Table 2, the base station control device 200 is placed at a point closest to the eleventh base station, and the moving group object 100 is assumed to move from the first base station 210 to the eleventh base station. Accordingly, the distance between the optical fiber and the eleventh base station is 0, and the distance between the moving group object 100 and the first base station 210 is also 0.

TABLE 2

| Base | Distance | | Dis- | | | | |
|---|---|---|---|---|---|---|---|
| sta- | [km] | Time | tance | Time | Time | Differ- | Ratio |
| tion | (optical | [μs] | [km] | [μs] | [μs] | ence | (Δ = 1.65 |
| No. | fiber) | (Δₙ) | (air) | (tₙ) | (tₙ + Δₙ) | [μs] | μs) |
| 1 | 10 | 49.5 | 0 | 0 | 49.5 | 16.5 | 10Δ |
| 2 | 9 | 44.55 | 1 | 3.3 | 47.85 | 14.85 | 9Δ |
| 3 | 8 | 39.6 | 2 | 6.6 | 46.2 | 13.2 | 8Δ |
| 4 | 7 | 34.65 | 3 | 9.9 | 44.55 | 11.55 | 7Δ |
| 5 | 6 | 29.7 | 4 | 13.2 | 42.9 | 9.9 | 6Δ |
| 6 | 5 | 24.75 | 5 | 16.5 | 41.25 | 8.25 | 5Δ |
| 7 | 4 | 19.8 | 6 | 19.8 | 39.6 | 6.6 | 4Δ |
| 8 | 3 | 14.85 | 7 | 23.1 | 37.95 | 4.95 | 3Δ |
| 9 | 2 | 9.9 | 8 | 26.4 | 36.3 | 3.3 | 2Δ |
| 10 | 1 | 4.95 | 9 | 29.7 | 34.65 | 1.65 | 1Δ |
| 11 | 0 | 0 | 10 | 33 | 33 | 0 | 0Δ |

Table 3 illustrates the frame offset of each base station if the base station control device 200 is placed near the first base station 210. In Table 3, the base station control device 200 is placed at a point closest to the first base station 210, and the moving group object 100 is assumed to move from the first base station 210 to the eleventh base station. Accordingly, the distance between the optical fiber and the first base station 210 is 0, and the distance between the moving group object 100 and the first base station 210 is also 0.

TABLE 3

| Base | Distance | | Dis- | | | | |
|---|---|---|---|---|---|---|---|
| sta- | [km] | Time | tance | Time | Time | Differ- | Ratio |
| tion | (optical | [μs] | [km] | [μs] | [μs] | ence | (Δ = 1.65 |
| No. | fiber) | (Δₙ) | (air) | (tₙ) | (tₙ + Δₙ) | [μs] | μs) |
| 1 | 0 | 0 | 0 | 0 | 0 | 0 | 0Δ |
| 2 | 1 | 4.95 | 1 | 3.3 | 8.25 | 8.25 | 5Δ |
| 3 | 2 | 9.9 | 2 | 6.6 | 16.5 | 16.5 | 10Δ |
| 4 | 3 | 14.85 | 3 | 9.9 | 24.75 | 24.75 | 15Δ |
| 5 | 4 | 19.8 | 4 | 13.2 | 33 | 33 | 20Δ |
| 6 | 5 | 24.75 | 5 | 16.5 | 41.25 | 41.25 | 25Δ |
| 7 | 6 | 29.7 | 6 | 19.8 | 49.5 | 49.5 | 30Δ |
| 8 | 7 | 34.65 | 7 | 23.1 | 57.75 | 57.75 | 35Δ |
| 9 | 8 | 39.6 | 8 | 26.4 | 66 | 66 | 40Δ |
| 10 | 9 | 44.55 | 9 | 29.7 | 74.25 | 74.25 | 45Δ |
| 11 | 10 | 49.5 | 10 | 33 | 82.5 | 82.5 | 50Δ |

Referring to FIGS. 5 to 7, the base station control device 200 in accordance with an exemplary embodiment of the present invention sends signals to be delivered to the moving group object 100 to the plurality of base stations at different timing based on the frame offsets. All the signals to be delivered to the moving group object 100 may reach the moving group object 100 at the same timing through antennas included in the plurality of base stations.

Alternatively, the base station control device 200 in accordance with another exemplary embodiment of the present invention may notify the plurality of base stations of calculated frame offsets, and the plurality of base stations may send the signals to the moving group object 100 based on time synchronized by the base station control device 200 and the frame offsets. Thereafter, the signals transmitted by the plurality of base stations at different timing may reach the moving group object 100 at the same timing.

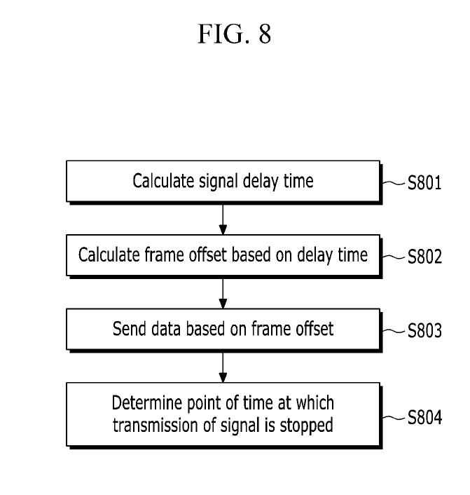

FIG. 8 is a flowchart illustrating a method of controlling, by the base station control device, a base station in accordance with an exemplary embodiment of the present invention.

Referring to FIG. 8, the base station control device 200 in accordance with an exemplary embodiment of the present invention calculates a signal delay time between the moving group object 100 and each of base stations and between each of the base stations and the base station control device 200 at step S801. The base station control device 200 in accordance with an exemplary embodiment of the present invention may calculate a first delay time regarding signal delay between the moving group object and each of the base stations based on the distance between the moving group object and each of the base stations and signal transfer speed in the air. Furthermore, the base station control device 200 may calculate a second delay time regarding signal delay between each of the base stations and the base station control device 200 based on the distance between each of the base stations and the base station control device 200 and signal transfer speed in a wired line that connects each of the base stations and the base station control device 200.

Thereafter, the base station control device 200 calculates the frame offset of each of the base stations based on the first delay time and second delay time of each of the base stations at step S802. The base station control device 200 in accordance with an exemplary embodiment of the present invention calculates the final delay time by adding the first delay time and second delay time of each of the base stations, performs a comparison between the calculated final delay times of the respective base stations, and determines a reference base station having the smallest final delay time. Furthermore, the base station control device 200 may determine a difference between the final delay time of the reference base station and the final delay time of another base station to be the frame offset of each of the base stations.

Thereafter, the base station control device 200 sends data to be delivered to the moving group object 100 to each of the base stations based on the frame offset of each of the base stations at step S803. Accordingly, the data transmitted by the base station control device 200 with respect to the moving group object 100 may simultaneously reach the moving group object 100 although the distance between each of the base stations and the moving group object 100 and the distance between the base station control device 200 and each of the base stations are different.

A base station that has sent a signal to the moving group object 100 may stop the transmission of the signal under the control of the base station control device 200. The base station control device 200 in accordance with an exemplary embodiment of the present invention may determine a point of time at which the transmission of a signal is stopped based on the uplink signal of the moving group object 100 at step S804. This may be determined in such a manner that the base station control device 200 assigns a cell ID to each of the base stations.

The base station control device 200 in accordance with an exemplary embodiment of the present invention may assign the same cell ID to a plurality of base stations connected to the base station control device 200 or may assign different cell IDs to the plurality of base stations. If the base station control device 200 assigns the same cell ID to a plurality of base stations connected to the base station control device 200, the moving group object 100 is unable to detect that a base station has been changed because the first base station and the second base station are connected to the same base station control device 200 and have the same cell ID although the moving group object 100 moves from the coverage of the first base station to the coverage of the second base station. That is, the moving group object 100 is unable to recognize that a cell has been changed because pilot signals transmitted by the base stations have the same start point and are the same. Accordingly, the moving group object 100 looks like moving within one cell. Thereafter, if the moving group object 100 moves to the coverage of the third base station, the first base station may stop the transmission of a signal. In an exemplary embodiment of the present invention, after the moving group object 100 passes through the coverage of a base station, a point of time at which each of the base stations stops the transmission of a signal may be determined based on uplink feedback. The moving group object 100 periodically measures the intensity of a pilot signals and sends a result of the measurement through uplink. The base station control device 200 may determine a point of time at which each of the base stations stops the transmission of a signal based on the uplink signal received from the moving group object 100. Alternatively, the base station control device 200 in accordance with another exemplary embodiment of the present invention may determine a point of time at which each of the base stations stops the transmission of a signal based on an uplink sounding reference signal received from the moving group object 100. That is, the base station control device 200 may determine a base station in which the moving group object 100 has been placed based on the uplink sounding reference signal of the moving group object 100 and may determine a base station that will stop the transmission of a signal. If the base station control device 200 has assigned different cell IDs to a plurality of base stations connected to the base station control device 200, the moving group object 100 may distinguish a cell that has sent a currently received signal based on a detected cell ID because signals dependent on the different cell IDs are different, and thus may feed an uplink signal back. In this case, the base station control device 200 may detect the uplink signal of the moving group object 100 and determine a proper base station suitable for the moving situation of the moving group object 100. If different cell IDs are assigned to a plurality of base stations connected to the base station control device 200, a pilot signal or a reference signal (RS) for demodulating the cell ID may function as interference. Such a problem may be solved using the same reference signal.

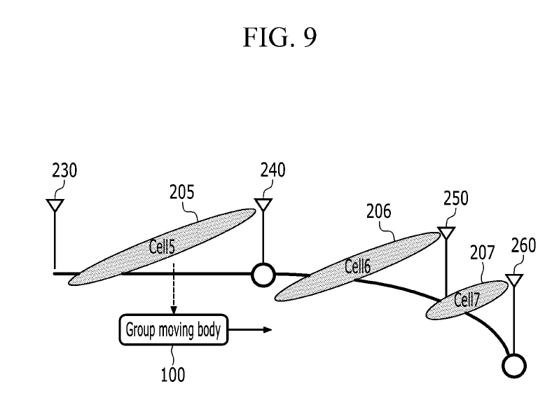

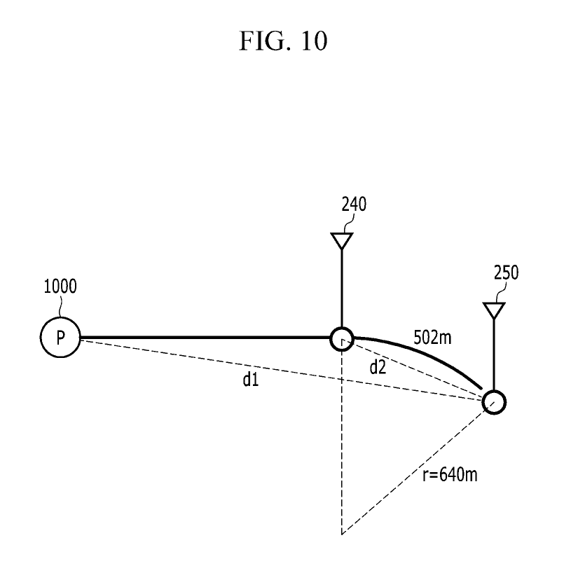

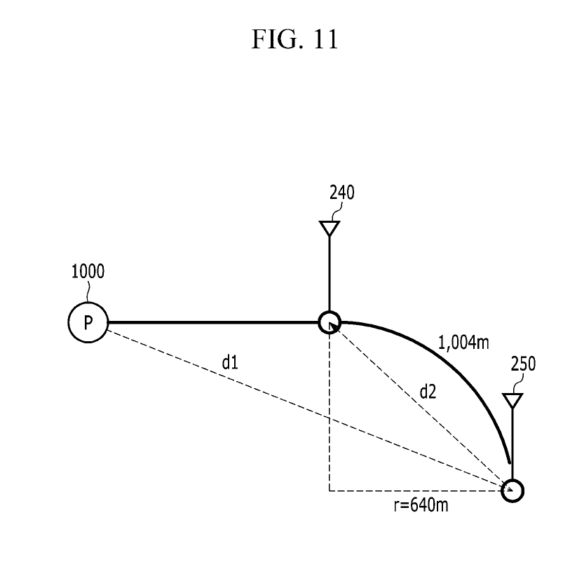

FIG. 9 is a diagram illustrating a moving group object operating in a curved line section in accordance with an exemplary embodiment of the present invention, and FIGS. 10 and 11 are diagrams illustrating a method of calculating a frame offset in a curved line section.

In an orthogonal frequency division multiplexing (OFDM) system, if the start point of a signal deviates from a cyclic prefix (CP) section, the signal may function as interference with the moving group object 100. Accordingly, in an OFDM system based on a multi-carrier transmission method, synchronization for each of base stations needs to be the same in the CP section. In general, in the case of LTE, a short CP is 4.7 μs or 5.2 μs. If a carrier frequency changes to a millimeter wave, the subcarrier interval, symbol length, and CP of an OFDM system need to be changed. The CP of a millimeter wave system may be about ⅕ or ⅛ compared to the CP of a mobile communication system, such as LTE or WiMAX. That is, in a mobile communication system using a millimeter wave, synchronization for each of base stations needs to maintain accuracy within a shorter CP length than the CP length of a mobile communication system, such as LTE.

Referring to FIG. 9, the moving group object 100 passing through the coverage of a third base station 230 moves to the coverage of a fourth base station to a sixth base station placed in a curved line section. In this case, there may be a difference in the signal transfer time of a signal received by the moving group object 100 depending on the curvature radius of the curved line section and the location of the base station in the curved line section.

In FIGS. 10 and 11, each of the curvature radii of curved line sections is 640 m. In FIG. 10, the distance between a fourth base station 240 and a fifth base station 250 is 502 m. In FIG. 11, the distance between a fourth base station 240 and a fifth base station 250 is 1004 m.

Referring to FIG. 10, assuming that a difference between the time that is taken for a signal transmitted by the fifth base station 250 to reach a first point 1000 and the time that is taken for a signal transmitted by the fourth base station 240 to reach the first point 1000 is Δa, and a difference between the time that is taken for a signal transmitted by the fifth base station 250 to reach a second point (i.e., a point at which the fourth base station is placed) and the time that is taken for a signal transmitted by the fourth base station 240 to reach the second point is Δb, a difference Δb-Δa between the differences Δa and Δb is 0.08 μs. In this case, the first point 1000 may be the start point of the curved line section in the moving path of the moving group object 100.

In FIG. 11, assuming that a difference between the time that is taken for a signal transmitted by the fifth base station 250 to reach the first point 1000 and the time that is taken for a signal transmitted by the fourth base station 240 is Δc, and a difference between the time that is taken for a signal transmitted by the fifth base station 250 to reach the second point and the time that is taken for a signal transmitted by the fourth base station 240 to reach the second point is Δd, a difference Δd-Δc between the differences Δc and Δd is 0.48 μs. That is, in a wireless communication system in accordance with an exemplary embodiment of the present invention, a frame offset may be included in a CP section in both the cases although the use of a millimeter wave is taken into consideration. In an exemplary embodiment of the present invention, a base station in a curved line section may be disposed at a shorter interval than a base station in a straight section so that the arrival time of a signal that has been controlled based on a frame offset according to the location of the moving group object 100 is safely included in a CP section.

A frame offset may be differently applied depending on the direction of a cell formed in each of base stations. For example, a frame offset may be differently applied to the case where the direction of a cell is opposite the moving direction of the moving group object 100 (i.e., a cell group A) and the case where the direction of a cell is the same as the moving direction of the moving group object 100 (i.e., a cell group B). Referring to FIG. 3, the directions of the cell2 202 and the cell4 204 formed in the first base station and the second base station are opposite the moving direction of the moving group object 100. The frame offsets of FIGS. 5 to 7 have been calculated based on the cell directions of FIG. 3. That is, in FIGS. 5 to 7, the frame offsets have been calculated with respect to the cell group A. In accordance with another exemplary embodiment of the present invention, with respect to the cell group B whose direction is the same as the moving direction of the moving group object 100, the frame offset may be calculated as described above. In this case, the frame offset is different from the frame offset of the cell group A.

As described above, in accordance with an exemplary embodiment of the present invention, the moving group object 100 may receive signals at the same time based on a predetermined frame offset. In this case, the frame offset may be previously determined based on the distance between the base station control device 200 and a base station and the distance between the base station and the moving group object 100. That is, the base station control device 200 may transfer a signal to each of base stations by taking a frame offset into consideration. The signals that have been subjected to time delay based on the frame offset may reach the moving group object 100 at the same time. For example, if the base station control device 200 transfers the same data to the first base station and the second base station, the moving group object 100 does not need to perform handover although it moves from the coverage of the first base station to the coverage of the second base station because the moving group object 100 can receive the same data from the first base station and the second base station at the same point of time. Signals that have not been synchronized may serve as interference with the moving group object 100 although they are the same data. In accordance with an exemplary embodiment of the present invention, the moving group object 100 may not perform handover between base stations because it receives at least two identical data that have been synchronized. Alternatively, a handover procedure between base stations can be very simplified because the moving group object 100 in accordance with another exemplary embodiment of the present invention may not perform synchronization with each of the first base station and the second base station at the boundary of the first and second base stations.

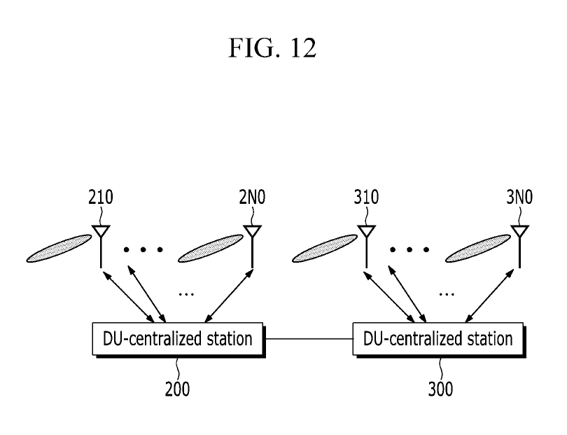

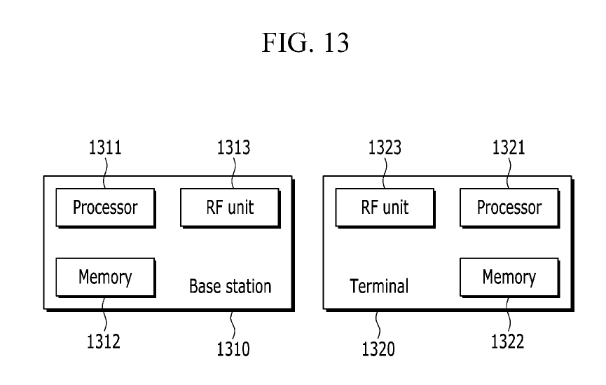

FIG. 12 is a diagram illustrating a wireless communication system including a plurality of base station control devices in accordance with an exemplary embodiment of the present invention.

Even when the moving group object 100 in accordance with an exemplary embodiment of the present invention passes through antennas connected to different base station control devices 200, the moving group object 100 can simplify a handover procedure based on a frame offset for the different base station control devices 200 very much. The base station control device 200 in accordance with an exemplary embodiment of the present invention may calculate a frame offset for an adjacent base station control device 300 by setting reference timing with the adjacent base station control device 300 through global positioning systems (GPSs) and sharing the number of DUs included in the base station control device 200, the interval between antennas connected to the base station control device 200 and the adjacent base station control device 300, or information about the location of the base station control device 200 with the adjacent base station control device 300. The base station control device 200 in accordance with an exemplary embodiment of the present invention can provide the same data to the moving group object 100 at the same point of time based on a frame offset for the adjacent base station control device 300 calculated as described above. The moving group object 100 can simplify a handover procedure even when the moving group object 100 moves from the coverage of the base station control device 200 to the coverage of the adjacent base station control device 300 very much.

As described above, in accordance with an exemplary embodiment of the present invention, data is transmitted to a moving group object based on a frame offset calculated based on a delay time between the signals of the moving group object, a base station, and a base station control device. Accordingly, a moving group object can easily perform handover because synchronization can be omitted when the moving group object performs handover between base stations. Furthermore, since a base station control device controls a frame offset for an adjacent base station control device, a moving group object can simplify a handover procedure and easily perform a handover procedure even when entering the coverage of a base station connected to another base station control device.

FIG. 13 is a block diagram illustrating a wireless communication system in accordance with an exemplary embodiment of the present invention.

Referring to FIG. 13, the wireless communication system in accordance with an exemplary embodiment of the present invention includes a base station 1310 and a terminal 1320.

The base station 1310 includes a processor 1311, a memory 1312, and a radio frequency (RF) unit 1313. The memory 1312 is connected to the processor 1311, and may store various information for driving the processor 1311 or may store at least one program executed by the processor 1311. The RF unit 1313 is connected to the processor 1311, and may send/receive radio signals. The processor 1311 may implement a function, process, or method proposed in accordance with an exemplary embodiment of the present invention. In the wireless communication system in accordance with an exemplary embodiment of the present invention, a radio interface protocol layer may be implemented by the processor 1311. An operation of the base station 1310 in accordance with an exemplary embodiment of the present invention may be implemented by the processor 1311.

The terminal 1320 includes a processor 1321, memory 1322, and an RF unit 1323. The memory 1322 is connected to the processor 1321, and may store various information for driving the processor 1321. The RF unit 1323 is connected to the processor 1321, and may send/receive radio signals. The processor 1321 may implement a function, step, or method proposed in accordance with an exemplary embodiment of the present invention. In the wireless communication system in accordance with an exemplary embodiment of the present invention, a radio interface protocol layer may be implemented by the processor 1321. An operation of the terminal 1320 in accordance with an exemplary embodiment of the present invention may be implemented by the processor 1321.

In an exemplary embodiment of the present invention, the memory may be placed inside or outside the processor and may be connected to the processor through already known means. The memory includes a variety of types of volatile or non-volatile storage media. For example, the memory may include read-only memory (ROM) or random access memory (RAM).

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of controlling, by a base station control device, a plurality of base stations disposed along a moving path of a moving group object, the method comprising:
determining a frame offset for the plurality of base stations based on a first delay time generated between the moving group object and the plurality of base stations and a second delay time generated between the plurality of base stations and the base station control device; and
transferring data to be transmitted to the moving group object to the plurality of base stations based on the frame offset.

2. The method of claim 1, wherein determining the frame offset comprises:
calculating the first delay time of each of the plurality of base stations based on a first distance between the moving group object and the plurality of base stations, and transfer speed of a signal in air;
calculating the second delay time of each of the plurality of base stations based on a second distance between the plurality of base stations and the base station control device, and transfer speed of a signal in an optical fiber connecting the plurality of base stations and the base station control device; and
determining the frame offset based on the first delay time and the second delay time.

3. The method of claim 2, wherein determining the frame offset based on the first delay time and the second delay time comprises:
determining a first base station that belongs to the plurality of base stations and that has a smallest final delay time that is a sum of the first delay time and the second delay time; and
determining a frame offset based on the final delay time of the first base station and a final delay time of base stations of the plurality of base stations other than the first base station.

4. The method of claim 1, wherein if the moving path is a curved line, a first interval between the plurality of base stations is shorter than a second interval between base stations disposed in a moving path of a straight line.

5. The method of claim 1, further comprising:
assigning an identical cell ID to the plurality of base stations; and
determining a point of time at which a transmission of signals of the plurality of base stations is stopped based on an uplink signal of the moving group object.

6. The method of claim 5, wherein the uplink signal comprises a sounding reference signal of the moving group object.

7. The method of claim 5, wherein the uplink signal comprises a measurement result of an intensity of a signal which has been measured by the moving group object and which corresponds to the data.

8. The method of claim 1, further comprising:
assigning different cell IDs to the plurality of base stations; and
determining a point of time at which a transmission of signals of the plurality of base stations is stopped based on an uplink signal generated based on the cell IDs in the moving group object.

9. A base station control device for controlling a plurality of base stations disposed along a moving path of a moving group object, the base station control device comprising:
at least one processor;
a memory; and
a radio frequency (RF) unit,
wherein the at least one processor determines a frame offset for the plurality of base stations based on a first delay time generated between the moving group object and the plurality of base stations and a second delay time generated between the plurality of base stations and the base station control device, and transferring data to be transmitted to the moving group object to the plurality of base stations based on the frame offset by executing at least one program stored in the memory.

10. The base station control device of claim 9, wherein when determining the frame offset, the at least one processor
calculates the first delay time of each of the plurality of base stations based on a first distance between the moving group object and the plurality of base stations and transfer speed of a signal in air,
calculates the second delay time of each of the plurality of base stations based on a second distance between the plurality of base stations and the base station control device and transfer speed of a signal in an optical fiber connecting the plurality of base stations and the base station control device, and
determines the frame offset based on the first delay time and the second delay time.

11. The base station control device of claim 10, wherein when determining the frame offset based on the first delay time and the second delay time, the at least one processor determines a first base station that belongs to the plurality of base stations and that has a smallest final delay time that is a sum of the first delay time and the second delay time, and determines a frame offset based on the final delay time of the first base station and a final delay time of base stations of the plurality of base stations other than the first base station.

12. The base station control device of claim 9, wherein if the moving path is a curved line, a first interval between the plurality of base stations is shorter than a second interval between base stations disposed in a moving path of a straight line.

13. The base station control device of claim 9, wherein the at least one processor assigns an identical cell ID to the plurality of base stations, and determines a point of time at which a transmission of signals of the plurality of base stations is stopped based on an uplink signal of the moving group object by executing the at least one program.

14. The base station control device of claim 13, wherein the uplink signal comprises a sounding reference signal of the moving group object.

15. The base station control device of claim 13, wherein the uplink signal comprises a measurement result of an intensity of a signal which has been measured by the moving group object and which corresponds to the data.

16. The base station control device of claim 9, wherein the at least one processor assigns different cell IDs to the plurality of base stations and determines a point of time at which transmission of signals of the plurality of base stations is stopped based on an uplink signal generated based on the cell IDs in the moving group object by executing the at least one program.

17. A method of sending data, by a base station disposed along a moving path of a moving group object, comprising:
receiving a frame offset with respect to a base station adjacent to the base station from a base station control device of the base station; and
sending the data to the moving group object based on the frame offset.

18. The method of claim 17, wherein the frame offset is calculated based on a first delay time generated between the moving group object and the base station and a second delay time generated between the base station and the base station control device.

19. The method of claim 17, wherein if the moving path is a curved line, an interval between the base station and the adjacent base station is shorter than an interval between other base stations disposed in a moving path of a straight line.

20. The method of claim 17, further comprising:
receiving an uplink signal from the moving group object; and
stopping transmission of a signal for the data based on a point of time at which the transmission of the signal is stopped, which is determined based on the uplink signal.
